(19) United States
(12) Patent Application Publication
(10) Pub. No.: US 2023/0195969 A1
(43) Pub. Date: Jun. 22, 2023

(54) METHOD FOR AUTOMATIC DESIGN CONCEPT DEFINITION AND ARCHETYPE SELECTION FOR LARGE SETS OF DESIGNS RESPECTING MULTIPLE DESCRIPTION SPACES

(71) Applicant: Honda Research Institute Europe GmbH, Offenbach/Main (DE)

(72) Inventors: Felix Lanfermann, Offenbach (DE); Sebastian Schmitt, Offenbach (DE); Stefan Menzel, Offenbach (DE)

(73) Assignee: Honda Research Institute Europe GmbH, Offenbach/Main (DE)

(21) Appl. No.: 17/557,005

(22) Filed: Dec. 20, 2021

(51) Int. Cl. G06F 30/27

(52) U.S. Cl. CPC G06F 30/27; G06F 2111/20

(57) ABSTRACT

A computer-implemented method obtains a dataset including design data samples, each sample representing a design variation of the physical object and including design features, each design feature included in a description space. The method determines concept candidates from the obtained dataset based on at least a feature value similarity of the design features, each concept candidate including a data sample group, for generating concept candidate configurations. The method calculates a metric for said configurations which defines a quality of the generated configurations and evaluates the design features of different description spaces, and evaluates said configurations based on the calculated metric to generate concepts. One or more representative data sample for each concept is determined based on at least one criterion. The determined representative data samples are output. A design process for the physical object based on the output representative data samples for each concept is performed.

### TECHNICAL FIELD

The disclosure concerns the field of engineering design optimization, evaluating of engineering design concepts and data mining. In particular, a method for automatic design concept definition and archetype selection for large sets of design data, which respects multiple description spaces, is proposed.

### BACKGROUND

In the field of engineering design processes, regularly a plurality of differing design candidates are created. The engineer subsequently analyses the created designs according to their specific characteristics and based on predefined design criteria. The design candidates may be classified and characterized based on their properties represented by features (design parameters, performance values, geometric features, and others). The features can include, for example, statistical or geometrical parameters derived from the design candidates. The performance values may include performance criteria of different technical disciplines under different environmental conditions.

The complete set of features describing a design candidate (or data sample) can be grouped into categories of features, sometimes called feature types. Each category represents characteristics of the design in one particular semantic context. Subsequently, a group of features, which share a common semantic meaning, in particular, which belong to the same feature category is referenced as a description space. For example, the combination of all features that represent the performance of the design candidates in a certain discipline for a set of specific environmental conditions may be denoted as one description space.

Design concepts comprise data samples that are similar with respect to their feature values in each respective description space. Each concept consists of data samples, which belong to the same group in each description space simultaneously. For example, a design concept may contain data samples that are similar with respect to all their design parameter values, their geometrical feature values, their performance values for different environmental conditions.

There currently exist optimization methods that enable to find independent solutions of high quality to design problems by considering two different description spaces. A single design criterion is applied to one description space and then optimized. However, a relation of the data samples representing design solutions in the two different description spaces is not provided.

However, analysing large datasets of design data, comprising a plurality of data samples, identifying and assessing meaningful design concepts based on an arbitrary number of description spaces and previously defined characteristics and preferences set by the design engineer is a complex undertaking requiring large computational sources.

It is desirable to provide the design engineer with a measure for automatically and efficiently identifying structures in large datasets of design data.

### SUMMARY

A computer-implemented method for performing a design process by analysing design data of a physical object according to an aspect addresses these issues, the method comprises steps of: obtaining a dataset including a plurality of data samples of design data, each data sample representing a design variation of the physical object, each data sample comprising a plurality of design features, each design features included in at least one of a plurality of description spaces; determining plural concept candidates from the obtained dataset based on at least a similarity of feature values of the design features, wherein each concept candidate includes a group of data samples, in order to generate plural concept candidate configurations; calculating a metric for the concept candidate configurations, wherein the calculated metric defines a quality of the generated concept candidate configurations, the metric evaluating the design features of different description spaces of the plurality of description spaces; evaluating the plural concept candidate configurations based on the calculated metric to generate concepts; determining a representative data sample for each of the concepts based on at least one selection criterion; outputting the determined representative data sample for each of the concepts; and performing the design process for the physical object based on the output representative data sample for each of the concepts.

### BRIEF DESCRIPTION OF THE DRAWINGS

FIG. 1 illustrates a dataset D including multiple data samples x₁, x₂, . . . , x_{N}_{_{D}}, the data samples including features f₁, f₂, . . . , f_{N}_{_{F}} in plural description spaces.

FIG. 2 illustrates generation of a dataset using free-form-deformation (FFD) in the airfoil design implementation of an embodiment.

FIG. 3 illustrates terminology of the method in an application to an airfoil design dataset.

FIG. 4 shows a normalized dataset in five description spaces (parameter space, geometric feature space, objective space 1, objective space 2 and objective space 3) in the airfoil design implementation of the method.

FIG. 5 depicts a result of the concept determination process in the airfoil design implementation an embodiment.

FIG. 6 depicts an evaluation of the result of the concept identification process in the airfoil design implementation of an embodiment.

FIG. 7 illustrates a selection of representative data samples of the identified concepts in the airfoil design implementation of an embodiment.

FIG. 8 shows a simplified flowchart, which depicts method steps implementing an embodiment.

### DETAILED DESCRIPTION

The computer-implemented method for performing a design process by analysing design data of a physical object according to an aspect addresses these issues, the method comprises steps of: obtaining a dataset including a plurality of data samples of design data, each data sample representing a design variation of the physical object, each data sample comprising a plurality of design features, each design feature included in one of a plurality of description spaces; determining plural concept candidates from the obtained dataset based on at least a similarity of feature values of the design parameters, wherein each concept candidate includes a group of data samples, in order to generate plural concept candidate configurations; calculating a metric for the concept candidate configurations, wherein the calculated metric defines a quality of the generated concept candidate configurations, the metric evaluating the design parameters of different description spaces of the plurality of description spaces; evaluating the plural concept candidate configurations based on the calculated metric to generate concepts; determining a representative data sample for each of the concepts based on at least one selection criterion; outputting the determined representative data sample for each of the concepts; and performing the design process for the physical object based on the output representative data sample for each of the concepts

The method according to the first aspect provides a capability to identify concepts in design datasets using a metric that balances three components against each other: the number of data samples within each concept, the intersection of different concepts within each description space and an intersection of the concepts with the predefined preferences or constraints on values of features in some description spaces.

Furthermore, the method enables to identify groups of similar solutions in plurality of relevant description spaces and provides an objective measure, which considers all descriptions spaces and the relations of identified data samples simultaneously.

The method provides a process for defining concepts and selecting representative data samples (or: archetypes), which identifies data samples, which show the best trade-off characteristics in the dataset for a given design problem.

Design concepts contain data samples, which are similar with respect to their feature values in each respective description space. Each concept consists of designs samples, which belong to the same group in each description space simultaneously. For example, a concept may contain data samples that are similar with respect to all their design parameters, their geometrical feature values, their performance values for different environmental conditions, and other feature values.

In conventional approaches, defining concepts has been restricted to two description spaces only. Concepts were limited in scope to only deal with design parameters and a single set of performance values. In engineering applications, these two description spaces are traditionally considered to be the most relevant spaces. However, not only provide concepts valuable insight into the design problem, but they also enable the engineer to derive representative data samples for the concepts. Representatives may be selected such that they represent an archetypal configuration of the concept, meaning that they share a substantial number of features with other data samples of the concept they originate from. These representative data samples may be used as prototypes for further design stages, such as a refinement of the initial design or serving as starting points for subsequent optimization studies under changed environmental conditions or case-based reasoning approaches. Since prototypes from different concepts represent different parts of the search space of the dataset, they generate improvement potential in multiple directions.

Concept identification represents a particular type of clustering problem, where corresponding clusters represent concepts in case the clustering of the data samples is preserved within all description spaces. Conventional clustering approaches cannot achieve this target, contrary to the method according to the aspect of the disclosure defined above.

The method is able to identify and objectively assess meaningful design concepts based on an arbitrary number of description spaces and previously defined characteristics and preferences. The core of the method is the metric determining a quality for the concept candidate configuration distribution. The metric balances three components against each other: the number of data samples within each concept, the intersection of different concepts within each description space and the intersection of the concepts with the predefined preferences or constraints on feature values in some or all description spaces. The method enables specifying such preferences as feature value intervals, directions in the descriptions space or a set of particular solutions of interest.

Further, the method enables generating new and optimized data samples, for example finding new data samples in an independent data generation process, which persecutes the target of optimizing specific features in specific description spaces, of exploring specific other features, or of avoiding specific other features in specific other description spaces. In these applications, the representative data samples or archetypical data samples selected for the concepts are selected to ensure to initialize and guide the search in the aforementioned applications most efficiently.

The method also achieves optimizing the evolvability of data samples by selecting the concepts and the selected representative data samples such that when new data samples are generated by a random variation of the feature values in one specific descriptions space, a distribution of the feature values of the data samples in the other descriptions spaces is advantageous or complies with some predetermined preferences.

The method is also capable of performing dataset compression, for example compressing the large dataset including a large initial number of data samples to a reduced number of few representative data samples, which still represent the most interesting part of the data set. The reduced number of data samples, the representative data samples of the concepts, may be used to reduce the required storage size and processing requirements for further data processing and analysis of the dataset substantially. Selecting the representative data samples and determining the concepts in a way to represent the compressed dataset achieves this effect.

The method further supports a design variant development, in particular by selecting the representative data samples of the concepts as a manageable amount of design variants that represent different parts of the design space.

The method also supports predicting feature values of new data samples in all description spaces in which the new data samples originally only include feature values in some selected description spaces by using the defined concepts and their representative data samples.

The method according to an embodiment includes the metric configured to evaluate the design features of at least three different description spaces.

According to an embodiment, the similarity of feature values of the design features includes at least a similarity in a first description space, in a second description space and in a third description space.

The metric according to an embodiment is configured to define the quality based on at least one of a performance parameter, a distance to a Pareto front, an inclusion of predefined data samples in the concept candidate configurations for each of the plurality of description spaces.

Before evaluating the concept candidate configurations using the calculated metric, specific data samples may be selected as data samples of interest. The metric may then be penalized in case less or more of these data samples of interest than desired are included in the corresponding concept candidate configuration.

In an embodiment, the method includes determining a predetermined number of the concept candidates for the plural concept candidate configurations. Alternatively, the method may include defining different numbers of the concept candidates for the concept candidate configurations from the dataset simultaneously, and evaluating the plural concept candidate configurations based on the metric and the different number of concept candidates in order to determine an optimized number of concept candidates for the plural concept candidate configurations. Alternatively, the method may optimize, based on the metric included in a fitness function, the similarity of the parameter values of the design features of the concept candidates in the step of determining the concept candidate configurations.

A fitness function is a particular type of objective function that is used to summarise, by a single or multiple numerals, how close a given design solution comes to achieving preset targets. Fitness functions are used in evolutionary and genetic algorithms and generally in numerical optimization to guide simulation and optimization processes towards optimal design solutions.

The at least one selection criterion comprises at least one of a predefined preference criterion, in particular a high performance, or low maintenance cost, or low weight, or any other criterion relevant to performance. The at least one selection criterion may comprise at least one of a determination criterion calculated based on a composition of the concept, in particular based on a distance to a mean computed based on feature values of the design parameters of the data samples of the concept, and a suitability as a starting point for performing the optimization process for the physical object, in particular preferring low variations of feature values in all description spaces for a small variation of the feature values of the representative data sample.

The metric may output increased numerical values for an increased quality of the concept candidate configuration.

The quality of a particular concept candidate configuration depends on a number of data samples of the dataset being included in all of the plural concept candidates of the particular concept candidate configuration, in particular the quality of the particular concept candidate configuration decreases for an increasing number of data samples of the dataset not included in any of the concept candidates of the concept candidate configuration.

Additionally or alternatively, the quality of the particular concept candidate configuration is high in case every data sample of the dataset is associated with one concept candidate of the concept candidate configuration.

Additionally or alternatively, the quality of the particular concept candidate configuration is high in case the number of data samples of each concept candidate is neither below a first threshold nor above a second threshold.

Additionally or alternatively, the quality of the particular concept candidate configuration is high in case the data samples of all concept candidates of the particular concept candidate configuration include all the data samples of a predetermined portion of the data samples in the dataset.

Additionally or alternatively, the quality of the particular concept candidate configuration is high in case each concept candidate approximates predetermined target characteristics in each description space, wherein, in particular, the target characteristics base at least on value ranges for particular feature values in particular description spaces, on a distance of the particular feature values of the particular description spaces to predetermined feature values.

In an embodiment, the method includes evaluating the metric for the concept candidate configurations comprising maximizing the metric using a numerical optimization algorithm, in particular a gradient based algorithm or an evolutionary or a swarm-based optimization algorithm, by changing the number of concept candidates of the concept candidate configuration and an association of each data sample (x₁, . . . , x_{N}_{_{D}}) of the design data in each description space with none, one or more concept candidates.

The step of evaluating the metric for the concept candidate configurations comprises using binary variables describing an association of each data sample in each description space to each concept candidate directly as optimization parameters for maximizing the metric.

Alternatively, the step of evaluating the metric for the concept candidate configurations comprises defining geometrical regions in each description space, which define an affiliation of the data samples to the concept candidates, and using geometric variables characterizing the geometric regions.

The step of calculating the metric for the concept candidate configurations according to an embodiment comprises counting a number |Cₐₗ| of the data samples for each concept candidate in each description space, wherein Cₐₗ is the set of data samples associated with concept candidate α∈1, . . . , N_{C} in a description space l∈1, . . . , N_{D}, counting numbers of data samples associated with multiple concept candidates in one description space, counting numbers of data samples not associated with any concept candidate, determining a size of the concept candidates in each description space. The embodiment of the method proceeds by calculating a concept quality measure Q_{α} of one concept candidate α according to

$${Q}_{α} = {\prod }_{k , l \neq k}^{{N}_{D S}} \sqrt[{N}_{DS}]{\frac{\vert \{ x ∈ {C}_{α k} ⋂ {C}_{α l} \vert x ∉ {⋃}_{β = 1 , β \neq α}^{{N}_{c}} {C}_{β k} \} \vert}{\vert {C}_{α k} \vert}} {F}_{S} ( \frac{\vert {C}_{α k} \vert}{{N}_{𝒟}} )$$

wherein N_{DS} denotes a number of the description spaces, the descriptions spaces are enumerated by Roman letters l, k, N_{C} denotes the number of concept candidates, the concepts are enumerated by Greek letters α,β, C_{αk} represents the set of data samples which are associated to concept α in descriptions space k, and a factor

$${F}_{s} ( c ) = \{ \begin{matrix}\sqrt{1 - {( \frac{c - s}{s} )}^{2}} , & if c < s \\ 1 , & if s < c < 1 - s \\ \sqrt{1 - {( \frac{c - 1 + s}{s} )}^{2}} , & if c > 1 - s\end{matrix}$$

with

$$c = \frac{\vert {C}_{α k} \vert}{{N}_{𝒟}}$$

and a freely selectable number 0≤s≤1, which favors the sizes of each concept to be between sN_{D} and (1−s)N_{D}, where N_{D} is the total number of data samples in the dataset. The embodiment proceeds by calculating the metric Q by aggregating the individual concept quality measures Q_{α} by computing a sum, Q=Σ_{α}^{N}^{_{C}} Q_{α}, or a product Q=Π_{α}^{N}^{_{C}} Q_{α} or by using another monotonic aggregation function of the individual concept quality measures Q_{α} for quantifying the quality of a concept candidate configuration.

The method according to an embodiment, further includes calculating the metric Q for the concept candidate configurations by regarding additionally preferred feature values of the design features represented in concept candidates by reducing the concept quality measure Q_{α} of one concept candidate if the preferred feature values are not included in a concept candidate according to

$${Q}_{α P} = {Q}_{α} \cdot {F}_{P} ( {a}_{α} )$$

$$wherein$$

$${F}_{P} ( {a}_{α} ) = \{ \begin{matrix}\sqrt{1 - {( \frac{{a}_{α} - p}{p} )}^{2}} , & if {a}_{α} < p \\ 1 , & if p < {a}_{α} < 1 - p \\ \sqrt{1 - {( \frac{{a}_{α} - 1 + p}{p} )}^{2}} , & if {a}_{α} > 1 - p\end{matrix}$$

with a freely selectable parameter 0≤p≤1 and

$${a}_{α} = \frac{{\sum }_{i = 1}^{{N}_{D S}} \vert {C}_{α i} ⋂ {P}_{i} \vert}{{\sum }_{i = 1}^{{N}_{D S}} \vert {P}_{i} \vert} .$$

Pᵢ with i=1, . . . , N_{DS} denotes the set of data samples with the preferred feature values in a description space i. A function F_{P} (α_{α}) measures a fulfilment of a requirement on the preferred feature values in the description spaces, and the requirement is formulated by defining a set of data samples of interest which should be included into each concept candidate. The method proceeds by calculating the metric Q by aggregating the individual concept quality measures Q_{α} by computing the sum Q=Σ_{α}^{N}^{_{C}} Q_{αP}, or the product Q=Π_{α}^{N}^{_{C}} Q_{αP}, or by using another monotonic aggregation function of the concept quality measure Q_{α} for quantifying the quality of a concept candidate configuration.

Calculating the metric Q for the concept candidate configurations according to an embodiment of the method comprises utilizing mutual information for quantifying how much information is gained about an association of the data samples with one specific concept candidate in one description space by acquiring knowledge about the association of the data samples with the one specific concept in another description space, and utilizing additionally information gained by knowing an association of data samples with a union of two concepts candidates provides on the association of data samples with the intersection of the two concept candidates in one description space. The method of this embodiment then proceeds by summing over the gained combinatorial information according to

$$Q = {\sum }_{α , β \neq α , j , k \neq j} I ( {C}_{α j} , {C}_{α k} ) [ 1 - I ( \{ {C}_{α j} ⋃ {C}_{β j} \} , \{ {C}_{α j} ⋂ {C}_{β j} \} ) ] {F}_{s} ( \vert {C}_{α j} \vert / {N}_{D} )$$

wherein I(X, Y) is the mutual information of the sets of variables X and Y, for calculating the metric (Q) based on applying information theory.

According to an embodiment of the method, performing the design process may comprise obtaining at least one new data sample, wherein for the at least one new data sample for at least one of the description spaces the feature values for the plurality of design features are unavailable. The step of performing the design process proceeds by associating the at least one new data sample to a specific concept of the concept based on the available feature values for the plurality of design features. The method then predicts feature values for the plurality of design features of the new data sample for which the feature values for the plurality of design features are unavailable based on the associated specific concept.

Performing the design process may comprise optimizing a design of the physical object based on a fitness function, wherein the fitness function is based on at least one of the calculated metric and the selection criterion.

The dataset may include data samples of engineering design data, each data sample representing a design of the physical object.

Each of the plural description spaces may be is characterized by a single design feature or a group of design features, wherein the group of design features includes a set of design data parameters of the physical object, or a set of geometrical features of the physical object, or a set of performance values of the physical object for defined conditions, or a latent representation of a machine learning approach, in particular of an auto-encoder or of a principal/independent component analysis PCA/ICA.

In the following description of an embodiment, an airfoil is used as a particular example for a physical object. Nevertheless, the physical object may be any other physically existing technical object, which results from performing an engineering design process, for example a vehicle or a vehicle part such as a vehicle chassis, a sea, air or space vehicle or part thereof, a part of a machine, such as a turbine blade, for example.

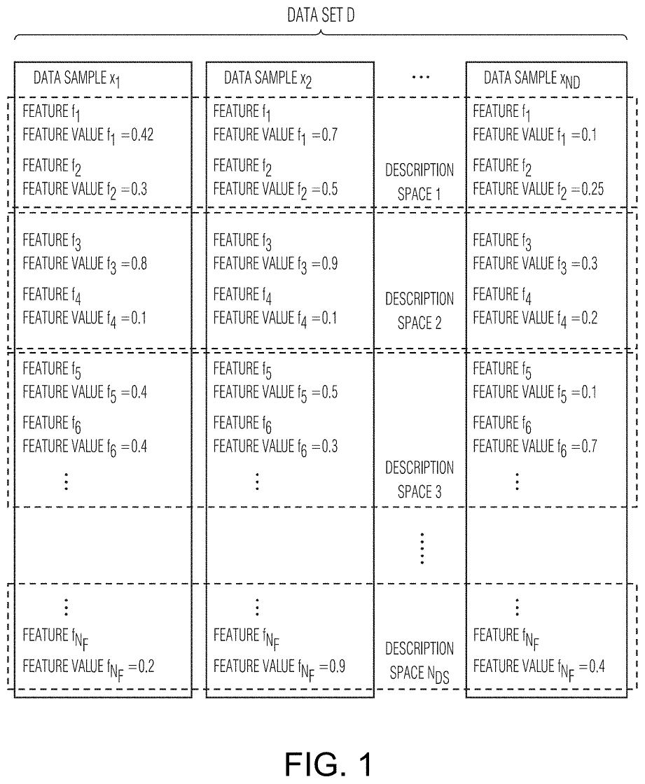

FIG. 1 illustrates a dataset D including multiple data samples x₁, . . . , x_{N}_{_{D}}, the data samples including features f₁, . . . , f_{N}_{_{F}} in description space 1, description space 2, . . . , up to description space N_{DS};

The term data sample refers to an element of the dataset D denoted by xᵢ. The data sample xᵢ represents a collection of all features f_{α} attributed with a data sample in expression (1)

xᵢ=(f₁,f₂, . . . ,f_{N}_{_{F}}), (1)

In expression (1), N_{F} is a total number of features fa. Therefore, a dimensionality of the data sample xᵢ, is N_{F}:

xᵢ∈ [symbol] ^{N}^{_{F}} (2)

The term feature (also: parameter) denotes the elements of each data sample xᵢ. Each data sample xᵢ is characterized by multiple features denoted by f_{σ}, with σ=1, . . . , N_{F}. For example, in case of an airfoil design problem, an airfoil corresponding to a data sample xᵢ can be characterized by design parameters of a constructive representation, by geometrical features, and by performance criteria, in order to provide a non-exhaustive list of three groups of parameters f_{σ}.

The features f_{σ} of the constructive representation (design parameters) may include control points of a spline representation, for example.

The features f_{σ} of the geometrical representation (geometrical parameters) may include a maximal airfoil thickness, an airfoil thickness at predefined fixed chord length positions, leading- and trailing-edge radii, for example.

The parameters f_{σ} of the performance criteria (performance features, performance values) may include values for lift coefficients and values for drag coefficients for predetermined air velocities and angles of attack, a value for weight, for example.

The term feature value (parameter value) denotes a value of a specific feature f_{σ} for a specific data sample xᵢ. For example, for the feature “maximal airfoil thickness”, the feature value might be “0.42”.

The term design parameters refers to a set of constructive design parameters pₘ, in case the dataset is the result of a design process, in which each resulting data sample xᵢ is a potential solution to a specific problem. The design is typically defined by a set of constructive design parameters pₘ. The design parameters pₘ, enable to construct the actual design therefrom. For example, in the specific case of an airfoil design, the design parameters pₘ may be the control points of the NURBS representation of the airfoil design.

Alternatively, displacement variables for a set of deformation control points which specify the FFD deformation of a given baseline airfoil design may form the design parameters pₘ.

In the general context, design parameters pₘ are one type of parameters in the sense of features f_{σ} of a data sample xᵢ.

The term evolvability describes a specific capability of a data sample xᵢ, meaning its characteristic to be easily adjustable to changing environmental conditions and the corresponding changes in the evaluation criteria. For the dataset being the result of a design process, the characteristic of evolvability amounts to the capability of design solutions to be easily adapted to changing environmental conditions or to changed design targets.

The term archetype refers to a data sample xᵢ, which is representative of a whole set of data samples xᵢ.

The term design is also used to denote the engineering discipline of design. Specific examples include, but are not limited to, aerodynamic performance evaluation, structural mechanics performance evaluation, crashworthiness assessment, and noise, vibration and harshness (NVH) evaluations.

The term description space corresponds to a type of features, sometimes also called feature category. Features can be categorized into different types of features, wherein each type is associated with a specific semantic meaning and called a description space, denoted by [symbol] ⱼ with j=1, . . . , N_{DS}. The parameter N_{DS} denotes the total number of description spaces [symbol] ⱼ. Each group of features of one type is referred to as description space:

[symbol]

ⱼ={f_{σ}:σ=σ_{j,min}, . . . ,σ_{j,max}} (3)

wherein the index σ enumerates the subset of features of the data sample xᵢ which defines the descriptions space j. For the specific example of the airfoil design, possible description spaces include at least the spaces spanned by
(1) all design parameters (description space [symbol] ₁);
(2) all geometrical features of the airfoil design, e.g., maximal airfoil thickness, airfoil thickness at predefined fixed chord length positions, leading- and trailing-edge radii, . . . (description space [symbol] ₂);
(3) all performance values (criteria) of one discipline (lift, drag, torque, . . . ) at airspeed U₁ and angle of attack α₁ (description space [symbol] ₃);
(4) all performance criteria of one discipline (lift, drag, torque, . . . ) at airspeed U₂ and angle of attack α₁ (description space [symbol] ₄);
(5) all performance criteria of one discipline (lift, drag, torque, . . . ) at airspeed U₁ and angle of attack α₂ (description space [symbol] ₅);
(6) all performance criteria of another discipline (stiffness, weight, vibrational eigenfrequencies, . . . ) at airspeed U₁ and angle of attack α₂ (description space [symbol] ₆).

It is evident that the dataset of the particular example of airfoil design may include a plurality of further possible specific description spaces.

In a predetermined engineering design data set, the designs are characterized in multiple description spaces. A common description space is the space of design parameters, which are used to create the design, e.g. parameters of the parametric CAD representation. A further common description space is the objective space, which comprises all considered performance values. Depending on the actual design problem, additional description spaces might be useful, such as statistical or geometrical features derived from the design, or flow field properties of a given design in case of fluid dynamic assessment. Identifying concepts amounts to finding different groups of designs, which share similar properties in all description spaces simultaneously.

The term design concept (short: concept) denotes a set of data samples xᵢ that are similar in all description spaces l. Each design concept defines a set of data samples xᵢ, in each description space l and all data samples xᵢ belong to the same group in each description space l simultaneously. A design concept constitutes an abstract representation of a set of designs sharing similar properties in terms of their design parameters along with comparable performance measures and a comparable behavior.

The method according to a particular embodiment are illustrated by discussing a particular example of airfoil design.

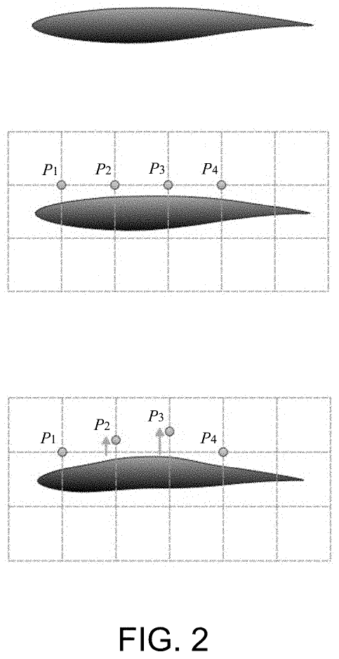

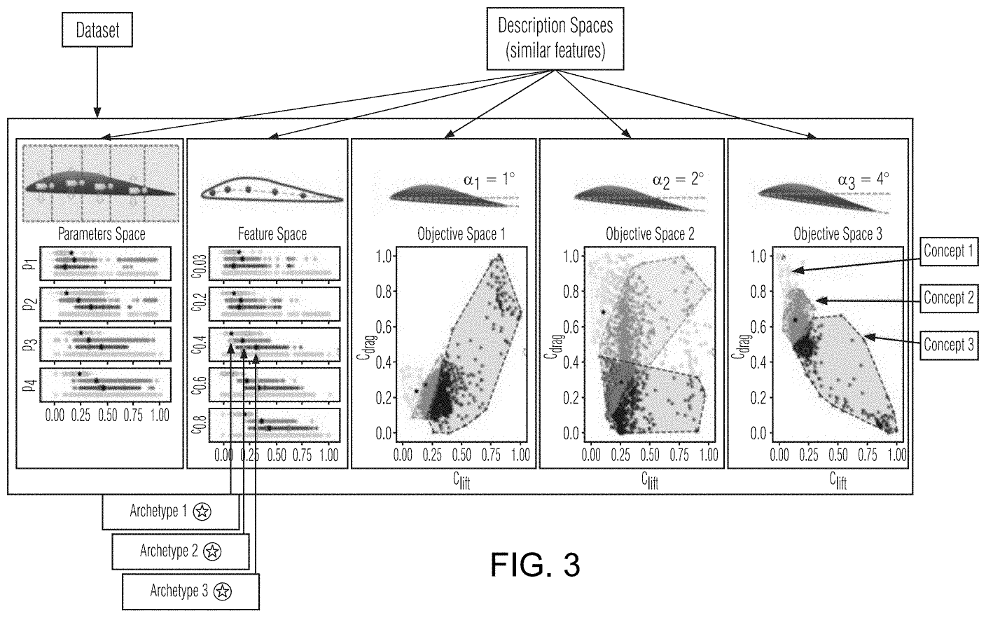

The two-dimensional airfoil profiles depicted in FIG. 2 are generated using a free-form deformation. The RAE2822 base profile in the upper portion of FIG. 2 is embedded in a lattice in the center portion of FIG. 2. Four of the lattice control points P₁, P₂, P₃, and P₄ are defined as free parameters. In order to generate the airfoil profile shown in the lower part of FIG. 2, the lattice control points P₁, P₂, P₃, and P₄ are varied. The entire dataset underlying FIG. 2 contains around 2500 data samples that are created using several evolutionary optimization runs. The particular example of airfoil design uses a dataset comprising several two-dimensional airfoil profiles. The airfoil profiles are constructed by deforming an RAE2822 base airfoil profile in a free-form-deformation setup, as illustrated in FIG. 3. For each airfoil profile constructed from the base airfoil profile, the method records in total, fifteen parameter values.

Four design parameters in the first description space describe a deformation of the profile and hence define the airfoil profile.

Additionally, the position of an airfoil camber line is calculated for five different positions, forming five features for each airfoil profile in the second description space.

In the particular example of airfoil design, an aerodynamic behavior of all airfoil profiles is evaluated at three different angles of attack, in the third, fourth and fifth description spaces, respectively.

This may be performed using any of known examples of a customized numerical simulation software for a solution of continuum mechanics problem, including computational fluid dynamics. A specific, nevertheless non-limiting example for this is the OpenFoam® software (OpenFoam® for Open Source Field Operation and Manipulation).

For each profile and angle of attack, the drag and lift coefficients are derived as performance indicators. Three different angles of attack are taken into consideration because airfoils typically operate under different conditions and a high performance under one angle of attack may not guarantee a high performance under different angles of attack.

As shown in FIG. 3, the parameters are split into five description spaces: the first description space is the design parameter space, the second description space is the geometric feature space, and the third, fourth and fifth description space are the objective space 1, objective space 2, and objective space 3, respectively. The target of the concept identification process is to identify reasonable concepts for these five description spaces. Identifying such concepts for the five description spaces requires determining groups of design concepts that share similarities with respect to all of the above-mentioned properties.

In order to incorporate the preference, which is to include the best trade-off solutions of the concepts during the concept identification process, a range of high performing trade-off samples is selected as sample designs of particular interest.

In the particular example of airfoil design, all non-dominated solutions of each of the three performance description spaces and additionally some sample designs that are nearby are selected.

For example, all data samples with a maximum distance in terms of lift and drag coefficient of less or equal than 0.05 to an existing solution may be considered to be nearby.

In the particular example of airfoil design, the method may target to define meaningful design concepts for such dataset, for example, the groups of airfoil designs, which fulfill the following requirements:
(1) A group of airfoil designs should have similar feature values in all description spaces.
   The requirement (1) provides the effect that a design concept containing airfoil designs with high lift values at large angles of attack, should also contain airfoils designs, which have similar lift and drag values at all other angles of attack, as well as similar design parameters and geometrical features, for example. Therefore, if the design target is a high lift airfoil, the identified concepts provide insights on the other performance criteria at other angles of attack as well as the knowledge on trade-off relations of similar data samples with similar geometrical features.
(2) Each data sample, which is identified to belong to one concept in one description space needs to belong to the same concept in all other description spaces as well.
   Requirement (2) reflects the necessary conditions that the definition of a concept is actually valid over all description spaces.
(3) The design concepts must not have a considerable overlap.
   Requirement (3) means, that the number of d data samples belonging to more than one design concept should be limited.
(4) A design concept should contain a reasonable fraction of data samples.
   A design concept may neither contain only a single data sample, and a design concept may not consist of the entire dataset. The specific meaning what the term “reasonable” in requirement (4) may refer to, for example, a minimal size and a maximal size of the design concepts, may be specifiable by a user.
(5) Constraints or preferences of the user need to be included. For example, the user wants the concepts to include best trade-off solutions in at least one description space or up to all performance description spaces.
(6) A small set of representative data samples (archetypes) from every design concept should be provided, which reflect some predetermined criteria (general criteria). Alternatively or additionally, the user may provide criteria (user-provided criteria).

For example, the representative data samples cover and represent a Pareto front of the complete objective space. Alternatively, the representative data samples may represent the complete dataset as best as possible.

Mathematical Description:

In order to assess the quality of a given definition of a set of concepts, the method evaluates the objective numerical measure Q (metric) for a given definition of concepts, which corresponds to a configuration of concept candidates:

Q=Π_{α}^{N}^{_{C}}Q_{αP} (4)

In expressions (4) and (5), the metric Q is a numerical measure for a given definition of concepts, N_{C} is the number of concepts, and the Greek indices α,β refer to the individual concept. The metric Q comprises the product of a metric Q_{αP} for each concept α of (5):

$${Q}_{α P} = {\prod }_{k , l \neq k}^{{N}_{DS}} \sqrt[{N}_{DS}]{\frac{\vert \{ x ∈ {C}_{α k} ⋂ {C}_{α l} \vert x ∉ {⋃}_{β = 1 , β \neq α}^{{N}_{c}} {C}_{β k} \} \vert}{\vert {C}_{α k} \vert}} {F}_{S} ( \frac{\vert {C}_{α k} \vert}{{N}_{𝒟}} ) {F}_{P} ( \frac{{\sum }_{i = 1}^{{N}_{DS}} \vert {C}_{α i} ⋂ {P}_{i} \vert}{{\sum }_{i = 1}^{{N}_{DS}} \vert {P}_{i} \vert} ) \qquad ( 5 )$$

For each description space, indexed by Roman letters k,l, the fractional term below the root evaluates the number of samples that belong to only one concept divided by the total number of samples |C_{αk}| associated with that concept in description space k. A high overlap between the individual concepts leads to low values for the fractional term and vice versa. In (5), the parameter N_{DS} denotes the number of description spaces and N_{C} the number of concepts. C_{αk} is the set of samples associated with concept α in description space k. The product of the roots for all non-identical description space combinations is multiplied by the factor F_{S} in (5), which is defined by expression (6):

$${F}_{s} ( \frac{\vert {C}_{α k} \vert}{{N}_{𝒟}} ) \qquad ( 6 )$$

with the parameter S according to (7)

0≤S≤1, (7)

and with N_{D} representing a total number of samples in the dataset. The size of each concept is therefore favored to be between

SN_{D} (8)

and

(1−S)N_{D} (9)

The factor F_{P} in expression (5) is given by expression (10):

$${F}_{P} ( \frac{{\sum }_{i = 1}^{{N}_{DS}} \vert {C}_{α i} ∩ {P}_{i} \vert}{{\sum }_{i = 1}^{{N}_{DS}} \vert {P}_{i} \vert} ) \qquad ( 10 )$$

Pᵢ with i=1, . . . , N_{DS} denotes the preferred parameter values in a description space i.
Pᵢ favors concepts that contain a specific proportional range of preference samples or constraints. The functions F_{S}(c) and F_{P}(α_{α}) are defined by:

$${F}_{s} ( c ) = \{ \begin{matrix}\sqrt{1 - {( \frac{c - s}{s} )}^{2}} , & if c < s \\ 1 , & if s < c < 1 - s \\ \sqrt{1 - {( \frac{c - 1 + s}{s} )}^{2}} , & if c > 1 - s\end{matrix} \qquad ( 11 )$$

$${F}_{P} ( {a}_{α} ) = \{ \begin{matrix}\sqrt{1 - {( \frac{{a}_{α} - p}{p} )}^{2}} , & if {a}_{α} < p \\ 1 , & if p < {a}_{α} < 1 - p \\ \sqrt{1 - {( \frac{{a}_{α} - 1 + p}{p} )}^{2}} , & if {a}_{α} > 1 - p\end{matrix} \qquad ( 12 )$$

The parameters s, p∈[0, 1] in expressions (11), (12) can be set to favor a desired concept size and the proportion of preferred data samples a concept contains, respectively.

The identification of reasonable concepts is performed in an optimization process. Each concept α is parametrized by an ellipsoid in each description space l, where each of the data samples inside the ellipsoid in that description space l is considered to belong to that concept α. For an n-dimensional description space l, an ellipsoid needs to be defined with a number of parameters

n(n+3)/2 (13)

with n denoting the number of dimensions of the description space in expression (13).

The discussed specific example of airfoil design pursues the target of identifying three airfoil design concepts. The description spaces have a dimension of four for a first description space of design parameters, a dimension of five for a second description space of geometric features, and a dimension of two for the third, fourth, and fifth description space of each objective description space. According to expression (13), a total number of parameters defining the concepts is given by expression (14):

3·(14+20+5+5+5)=147 (14)

An evolutionary algorithm modifies these 147 parameters by maximizing the metric Q according to (4). The evolutionary algorithm may be an example of a particle-swarm optimization (PSO), a covariance matrix adaptation evolutionary strategy (CMA-ES) or any optimization algorithm. Performing the evolutionary algorithm enables to arrive at an optimal distribution of concepts by maximizing the metric Q of expression (4).

In the particular example of airfoil design, the method identifies three concepts, each concept of the three concepts covering parts of all three description spaces.

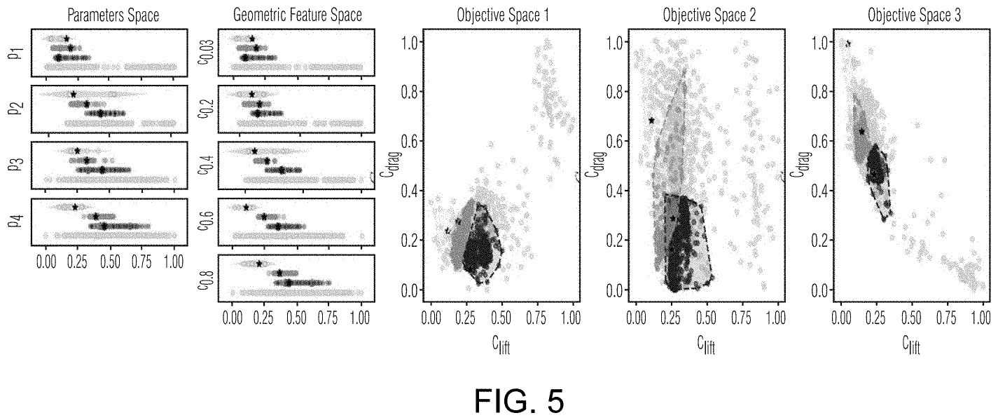

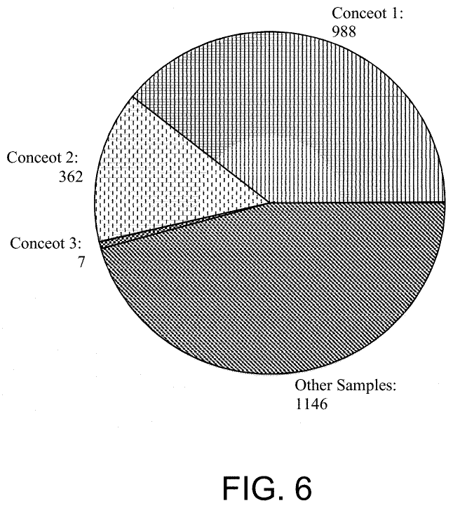

FIG. 5 shows a number of d data samples that are associated with each of the three identified concepts and an overlap of the three concepts in each description space. In FIG. 6, the method identifies three concepts that vary highly in their extent.

In the particular example of airfoil design, for each of the three concepts, the data sample that is closest to a geometric mean of its respective concept in the parameter space is selected as a representative data sample for the respective concept. Each representative data sample represents a concept in each description space and can be used to further develop a manageable amount of design alternatives from the representative data sample.

The concepts can further be used to predict features of additional data samples. For data samples that have not been generated in the original process, or for which not all feature values have been derived, only limited information might be available.

In the particular example of airfoil design, additional airfoil samples that were not generated in a free form deformation process might be added to the dataset. The additional airfoil data samples cannot be described within the original parameter space, however, all feature values for each feature in the geometric feature space can be computed. Based on a proximity of the additional data samples to the originally discovered concepts in the geometric feature space, their feature values can be predicted. Any additional data samples that lie within the extent of a concept in one description space will likely belong to the concept in the other description spaces.

In the particular example of airfoil design, the calculation of the aerodynamic values drag coefficient and lift coefficient requires most of the computation time. In order to predict these aerodynamic values for additional samples, the method uses the identified concepts to predict these aerodynamic values for additional data samples thus creates a significant benefit, since the computation time will decrease significantly.

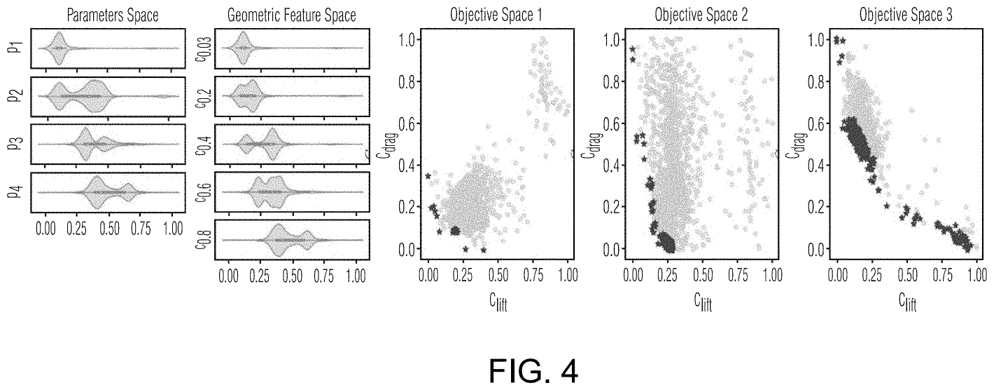

FIG. 4 shows a normalized dataset in five description spaces in the airfoil design implementation of the method. FIG. 4 arranges the five description spaces from left to right, the (design) parameter space, the geometric feature space, a first objective space, a second objective space and a third objective space arranged.

In the parameter space and in the geometric feature space, for each feature included in the respective description space, a distribution of data samples is shown for each individual parameter.

FIG. 4 depicts the first objective space, the second objective space and the third objective space with two dimensions. In the first objective space, the second objective space and the third objective space, data samples of a particular interest are marked.

FIG. 5 depicts a result of the concept determination process in the airfoil design implementation of an embodiment.

FIG. 5 depicts five description spaces, from left to right are the design parameter space, the geometric parameter space, a first objective space, a second objective space and a third objective space arranged.

The method determines three concepts, for each of the determined three concepts, a representative data sample is selected. The selected representative is marked in FIG. 5 using a star.

Each determined concept covers parts of each description space.

FIG. 6 depicts an evaluation of the result of the concept identification process in the airfoil design implementation of an embodiment.

As shown in FIG. 6, the first concept comprises 988 data samples. The second concept includes 362 data samples. The third concept includes 7 data samples. The other 1146 data samples d do not form part of any determined concept.

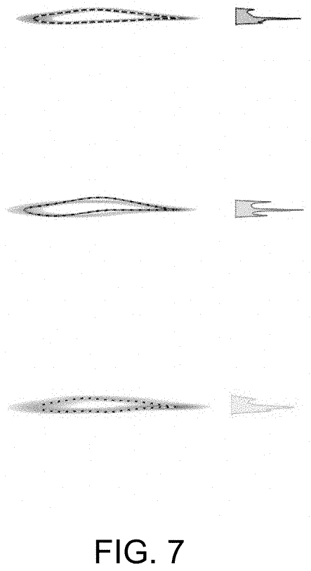

FIG. 7 depicts a selection of concept representatives of the three identified concepts in the airfoil design implementation of an embodiment. The three concepts are shown in the upper part of FIG. 7, the center part of FIG. 7 and the lower part of FIG. 7 respectively. For each of the three determined concepts, a representative data sample is shown with a dashed line. The spatial distribution of the representative data sample for each of the three determined concepts is shown in the shaded area behind and surrounding the dashed line of the representative data sample. A vertical distribution of the data samples of each concept is shown to the left of the concept.

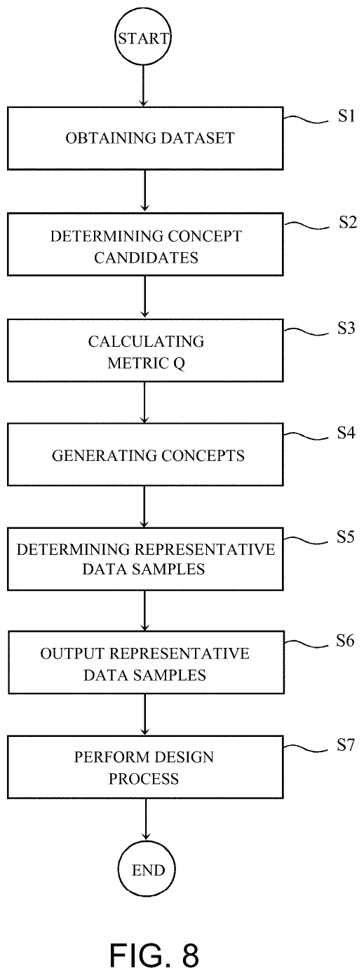

FIG. 8 shows a simplified flowchart, which depicts method steps of the computer-implemented method for performing a design process by analysing design data of a physical object.

In step S1, a dataset D including a plurality of data samples x₁, . . . , x_{N}_{_{D}} of design data is obtained. Each data sample xᵢ represents a design variation of a physical object. Each data sample xᵢ comprises a plurality of design features f₁, . . . , f_{N}_{_{F}}, wherein each design feature is included in one of a plurality of description spaces.

The method proceeds with a step S2 of determining plural concept candidates from the obtained dataset D based on at least a similarity of feature values of the design features f₁, . . . , f_{N}_{_{F}}. Each determined concept candidate includes a group of data samples,

In step S3, a metric Q for the concept candidate configurations is calculated. The calculated metric Q defines a quality of the generated concept candidate configurations and evaluates the design features f₁, . . . , f_{N}_{_{F}} of different description spaces of the plurality of description spaces.

In step S4, the plural concept candidate configurations are evaluated based on the calculated metric Q to generate concepts.

In step S5, from each generated concept, one or more representative data samples for each of the generated concepts are determined based on at least one selection criterion.

The determined representative data samples for each of the concepts are then output in step S6.

In step S7, the design process for the physical object based on the output representative data samples for each of the concepts is performed.

Subsequently, the physical object may be manufactured based on a resulting design from the performed design process.

The efficiency of this measure renders it particularly useful in the illustrative example of designing physical objects, for example airfoil design as well as on a real-world inspired vehicle design optimization.

The measure also enables performing data compressing of large datasets to a subset of data samples representing semantically relevant design concepts of the large dataset.

Further application areas for the method include recommendation systems for market places. In this particular example of a recommendation system, a dataset may be obtained from a market place where each data sample represents a specific customer, each description space represents a respective affinity of a customer to buy certain products of specific product type, and a concept represents a group of customers with similar preferences for each product type.

What is claimed is:

1. A computer-implemented method for performing a design process by analysing design data of a physical object, the computer-implemented method comprising:
obtaining a dataset (D) including a plurality of data samples (x₁, . . . , x_{N}_{_{D}}) of design data, each data sample xᵢ representing a design variation of the physical object and comprising a plurality of design features (f₁, . . . , f_{N}_{_{F}}), each design feature fᵢ included in at least one of a plurality of description spaces;
determining plural concept candidates from the obtained dataset (D) based on at least a similarity of feature values of the design features (f₁, . . . , f_{N}_{_{F}}), each concept candidate including a group of data samples, for generating plural concept candidate configurations;
calculating a metric (Q) for the concept candidate configurations, the calculated metric (Q) defining a quality of the generated concept candidate configurations, the metric (Q) evaluating the design features (f₁, . . . , f_{N}_{_{F}}) of different description spaces of the plurality of description spaces;
evaluating the plural concept candidate configurations based on the calculated metric (Q) to generate concepts;
determining at least one representative data sample for each of the concepts based on at least one selection criterion;
outputting the determined at least one representative data sample for each of the concepts;
performing the design process for the physical object based on the output at least one representative data sample for each of the concepts.

2. The computer-implemented method according to claim 1, wherein
the metric (Q) is configured to evaluate the design features (f₁, . . . , f_{N}_{_{F}}) of at least three of the different description spaces.

3. The computer-implemented method according to claim 1, wherein
the similarity of feature values of the design features (f₁, . . . , f_{N}_{_{F}}) includes at least a similarity in a first description space, in a second description space and in a third description space.

4. The computer-implemented method according to claim 1, wherein
the metric (Q) is configured to define the quality based on at least one of a performance value, a distance to a Pareto front, on inclusion of predefined data samples in the concept candidate configurations for each of the plurality of description spaces.

5. The computer-implemented method according to claim 1, wherein the method includes
determining a predetermined number of the concept candidates for the plural concept candidate configurations; or
defining different numbers of the concept candidates for the concept candidate configurations from the dataset (D) simultaneously, and evaluating the plural concept candidate configurations based on the metric (Q) and the different number of concept candidates in order to determine an optimized number of concept candidates for the plural concept candidate configurations; or
optimizing, based on the metric (Q) included in a fitness function, the similarity of the feature values of the design features (f₁, . . . , f_{N}_{_{F}}) of the concept candidates in the step of determining the concept candidate configurations.

6. The computer-implemented method according to claim 1, wherein
the at least one selection criterion comprises at least one of
a predefined preference criterion, in particular a high performance, or low maintenance cost, or low weight, or any other criterion relevant to performance,
a determination criterion calculated based on a composition of the concept, in particular based on a distance to a mean computed based on feature values of the design features (f₁, . . . , f_{N}_{_{F}}) of the data samples (xᵢ, xⱼ . . . ) of the concept, and
a suitability as a starting point for performing the optimization process for the physical object, in particular preferring low variations of feature values in all description spaces for a small variation of the feature values of the representative data sample xᵢ.

7. The computer-implemented method according to claim 1, wherein
the metric (Q) outputs increased numerical values for an increased quality of the concept candidate configuration.

8. The computer-implemented method according to claim 1, wherein
the quality of a particular concept candidate configuration depends on a number of data samples of the dataset (D) being included in all of the plural concept candidates of the particular concept candidate configuration, in particular the quality of the particular concept candidate configuration decreases for an increasing number of data samples of the dataset (D) not included in any of the concept candidates of the concept candidate configuration; and
the quality of the particular concept candidate configuration is high in case every data sample of the dataset (D) is associated with one concept candidate of the concept candidate configuration; and
the quality of the particular concept candidate configuration is high in case the number of data samples of each concept candidate is neither below a first threshold nor above a second threshold;
the quality of the particular concept candidate configuration is high in case the data samples of all concept candidates of the particular concept candidate configuration include all the data samples of a predetermined portion of the data samples in the dataset (D) or a portion of the predetermined portion that is neither below a first threshold nor above a second threshold;
the quality of the particular concept candidate configuration is high in case each concept candidate approximates predetermined target characteristics in each description space, wherein, in particular, the target characteristics base at least on value ranges for particular feature values in particular description spaces, on a distance of the particular feature values of the particular description spaces to predetermined feature values.

9. The computer-implemented method according to claim 1, wherein
evaluating the metric (Q) for the concept candidate configurations comprises maximizing the metric (Q) using a numerical optimization algorithm, in particular a gradient based algorithm or an evolutionary or swarm-based optimization algorithm, by changing the number of concept candidates of the concept candidate configuration and an association of each data sample of the design data in each description space with none, one or more concept candidates.

10. The computer-implemented method according to claim 9, wherein
evaluating the metric (Q) for the concept candidate configurations comprises using binary variables describing an association of each data sample in each description space to each concept candidate directly as optimization parameters for maximizing the metric (Q); or
defining geometrical regions in each description space, which define an affiliation of the data samples to the concept candidates, and using geometric variables characterizing the geometric regions.

11. The computer-implemented method according to claim 1, wherein calculating the metric (Q) for the concept candidate configurations comprises
counting a number |C_{αl}| of the data samples for each concept candidate in each description space, wherein Cₐₗ is the set of data samples associated with concept candidate a in a description space l,
counting numbers of data samples associated with multiple concept candidates in one description space,
counting numbers of data samples not associated with any concept candidate,
determining a size of the concept candidates in each description space, and
calculating a concept quality measure Q_{α} of one concept candidate according to
$${Q}_{α} = {\prod }_{k , l \neq k}^{{N}_{D S}} \sqrt[{N}_{DS}]{\frac{\vert \{ x ∈ {C}_{α k} ⋂ {C}_{α l} \vert x ∉ {⋃}_{β = 1 , β \neq α}^{{N}_{c}} {C}_{β k} \} \vert}{\vert {C}_{α k} \vert}} {F}_{S} ( \frac{\vert {C}_{α k} \vert}{{N}_{𝒟}} )$$
wherein N_{DS} denotes a number of the description spaces and N_{C} the number of concept candidates, and a factor
$${F}_{s} ( c ) = \{ \begin{matrix}\sqrt{1 - {( \frac{c - s}{s} )}^{2}} , & if c < s \\ 1 , & if s < c < 1 - s \\ \sqrt{1 - {( \frac{c - 1 + s}{s} )}^{2}} , & if c > 1 - s\end{matrix}$$
with 0≤s≤1 which favors the size of each concept to be between sN_{D} and (1−s)N_{D}, where N_{D} is the total number of data samples in the dataset, and
calculating the metric (Q) by aggregating the individual concept quality measures Q_{α} by computing a sum, Q=Σ_{α}^{N}^{_{C}} Q_{α}, or a product Q=Π_{α}^{N}^{_{C}} Q_{α} or by using another monotonic aggregation function of the individual concept quality measures Q_{α} for quantifying the quality of a concept candidate configuration.

12. The computer-implemented method according to claim 11, wherein calculating the metric (Q) for the concept candidate configurations further comprises
regarding additionally preferred features values of the design features (f₁, . . . , f_{N}_{_{F}}) represented in concept candidates by reducing the concept quality measure Q_{α} of one concept candidate if the preferred feature values are not included in a concept candidate according to
$${Q}_{α P} = Q \cdot {F}_{P} ( {a}_{α} )$$
$$wherein$$
$${F}_{P} ( {a}_{α} ) = \{ \begin{matrix}\sqrt{1 - {( \frac{{a}_{α} - p}{p} )}^{2}} , & if {a}_{α} < p \\ 1 , & if p > {a}_{α} < 1 - p \\ \sqrt{1 - {( \frac{{a}_{α} - 1 + p}{p} )}^{2}} , & if {a}_{α} > 1 - p\end{matrix}$$
with 0≤p≤1 and
$${a}_{α} = \frac{{\sum }_{i = 1}^{{N}_{D S}} \vert {C}_{α i} ∩ {P}_{i} \vert}{{\sum }_{i = 1}^{{N}_{D S}} \vert {P}_{i} \vert}$$
with Pᵢ with i=1, . . . , N_{DS} denoting the set of preferred feature values in a description space i and a function F_{P} (α_{α}) measures a fulfilment of a requirement on the preferred feature values in the description spaces, and the requirement is formulated by defining a set of data samples of interest which should be included into each concept candidate, and
calculating the metric (Q) by aggregating the individual concept quality measures Q_{αP} by computing the sum Q=Σ_{α}^{N}^{_{C}} Q_{αP}, or the product Q=Π_{α}^{N}^{_{C}} Q_{αP}, or by using another monotonic aggregation function of the concept quality measure Q_{αP} [for quantifying the quality of a concept candidate configuration].

13. The computer-implemented method according to claim 1, wherein calculating the metric (Q) for the concept candidate configurations comprises
utilizing mutual information for quantifying how much information is gained about an association of the data samples with one specific concept candidate in one description space by acquiring knowledge about the association of the data samples with the one specific concept in another description space, and
utilizing additionally information gained by knowing an association of data samples with a union of two concepts candidates provides on the association of data samples with the intersection of the two concept candidates in one description space, and
summing over the gained combinatorial information according to
$$Q = {\sum }_{α , β \neq α , j , k \neq j} I ( {C}_{α j} , {C}_{α k} ) [ 1 - I ( \{ {C}_{α j} ⋃ {C}_{β j} \} , \{ {C}_{α j} ∩ {C}_{β j} \} ) ] {F}_{s} ( \vert {C}_{a j} \vert / {N}_{D} )$$
wherein I(X, Y) is the mutual information of the sets of variables X and Y, for calculating the metric (Q) based on information theory.

14. The computer-implemented method according to claim 1, wherein performing the design process comprises
obtaining at least one new data sample xⱼ wherein for the at least one new data sample xⱼ for at least one of the description spaces the feature values for at least one design feature of the plurality of design features (f₁, . . . , f_{N}_{_{F}}) are unavailable;
associating the at least one new data sample xⱼ to a specific concept based on the available feature values for the plurality of design features (f₁, . . . , f_{N}_{_{F}}),
predicting feature values for at least one design feature of the plurality of design features (f₁, . . . , f_{N}_{_{F}}) of the new data sample xⱼ for which the feature values for at least one design feature of the plurality of design features (f₁, . . . , f_{N}_{_{F}}) are unavailable based on the associated specific concept.

15. The computer-implemented method according to claim 1, wherein
performing the design process comprises optimizing a design of the physical object based on a fitness function, wherein the fitness function is based on at least one of the calculated metric (Q) and the selection criterion.

16. The computer-implemented method according to claim 1, wherein
the dataset includes data samples (x₁, . . . , x_{N}_{_{D}}) of engineering design data, each data sample xᵢ representing a design of the physical object,
each of the plural description spaces is characterized by a single design feature fᵢ or a group of design features (fᵢ, fⱼ, . . . ), wherein the group of design features (fᵢ, fⱼ, . . . ) includes one of a set of design data parameters of the physical object, a set of geometrical features of the physical object, a set of performance values of the physical object for defined conditions, and a latent representation of a machine learning approach, in particular of an auto-encoder or of a principal/independent component analysis PCA/ICA.
